(19) United States
(12) Patent Application Publication
(10) Pub. No.: US 2014/0172303 A1
(43) Pub. Date: Jun. 19, 2014

(54) METHODS AND SYSTEMS FOR ANALYZING THE QUALITY OF A WELLBORE

(71) Applicant: Smith International, Inc., Houston, TX (US)

(72) Inventor: Hani Ibrahim, The Woodlands, TX (US)

(73) Assignee: Smith International, Inc., Houston, TX (US)

(21) Appl. No.: 14/105,336

(22) Filed: Dec. 13, 2013

Related U.S. Application Data
(60) Provisional application No. 61/738,780, filed on Dec. 18, 2012.

(51) Int. Cl. G01V 9/00

(52) U.S. Cl. CPC G01V 9/00
USPC 702/6

(57) ABSTRACT

A method of performing wellbore operations includes calculating, based on measurements obtained by drilling a wellbore, at least one wellbore quality factor of a wellbore quality index; and performing at least one wellbore operation in a wellbore through a subterranean formation, based on the at least one calculated wellbore quality factor.

### CROSS-REFERENCE TO RELATED APPLICATIONS

This application claims priority to and the benefit of U.S. Patent Application No. 61/738,780, filed on Dec. 18, 2012, the contents of which are incorporated by refer rice herein.

### BACKGROUND

Wellbore quality is a term commonly used in the drilling industry, and is most often associated with a smooth, in-gauge well with minimal spiraling. Good well quality may allow for enhanced drilling performance, ease of running casing in the well, improved logging responses, and quality cementing of the casing in place. Several causes of wellbore quality impairment include bottom hole assembly (BHA) selection, drilling parameters, wellbore fluid selection (type and weight), connection and tripping practices, hole cleaning, vibration management, directional drilling, etc.

### SUMMARY

This summary is provided to introduce a selection of concepts that are further described below in the detailed description. This summary is not intended to identify key or essential features of the claimed subject matter, nor is it intended to be used as an aid in limiting, the scope of the claimed subject matter.

In one aspect, embodiments disclosed herein relate to a method of performing wellbore operations that includes calculating, based on measurements obtained by drilling a wellbore, at least one wellbore quality factor of a wellbore quality index; and performing at least one wellbore operation in a wellbore through a subterranean formation, based on the at least one calculated wellbore quality factor.

In another aspect, embodiments disclosed herein relate to a method of assessing wellbore hole quality that includes calculating, based on measurements obtained by drilling a well, at least one wellbore quality factor of a wellbore quality index; comparing the calculated wellbore quality factor against a predetermined value of the acceptability of the calculated wellbore quality Factor; and displaying results of comparison.

Other aspects and advantages of the claimed subject matter will be apparent from the following description and the appended claims.

### BRIEF DESCRIPTION OF DRAWINGS

FIG. 1 is a schematic of a wellbore.

FIG. 2 is a schematic of a wellbore.

FIG. 3 is a schematic Of a wellsite.

FIG. 4 is a schematic of a computer system that may implement one or more embodiments.

### DETAILED DESCRIPTION

Specific embodiments will now be described in detail with reference to the accompanying figures. Like elements in the various figures are denoted by like reference numerals for consistency.

In the following detailed description of embodiments, numerous specific details are set forth in order to provide a more thorough understanding. However, it will be apparent to one of ordinary skill in the art that the invention may be practiced without these specific details. In other instances, well-known features have not been described in detail to avoid unnecessarily complicating the description

In general, embodiments are directed to analysis of a wellbore traversing through a subterranean formation. Embodiments disclosed herein relate to methods and systems for calculating a wellbore quality index value from downhole measurements and assessing wellbore quality from such calculations for consideration in future drilling or other well operations. That is, instead of assigning, a subjective score on the basis of visual observation, a formulaic approach to analysis of downhole measurements may allow for greater consistency between wells to minimize or reduce potential human errors in assessing quality indicators that exist in conventional scorecards. A quality wellbore may ideally be a gauged, non-ellipsed wellbore without substantial tortuosity or induced fractures, and no washouts to enable proper zonal isolation through effective cementing of a properly centered casing string. However, while such wellbore properties may be idealized, one or more of such properties may be achieved by using the methods disclosed herein.

Thus, one or more embodiments relate to the generation and analysis of well data (from a well being drilled or from an offset well) that is assessed against a wellbore quality index so that preventative and/or remediative actions may be taken in subsequent drilling and/or completion operations. In one or more embodiments, the wellbore quality index may include sub-indices related to borehole shape, dogleg severity, tortuosity, and/or ovality, for example. One or more of such sub-indices may be assessed individually to give an indicator of wellbore quality. The comparison of a well (target or drilled) against one or more sub-indices of the wellbore quality index may be displayed for a user and/or used to more accurately represent wellbore quality issues and risks for subsequent operations.

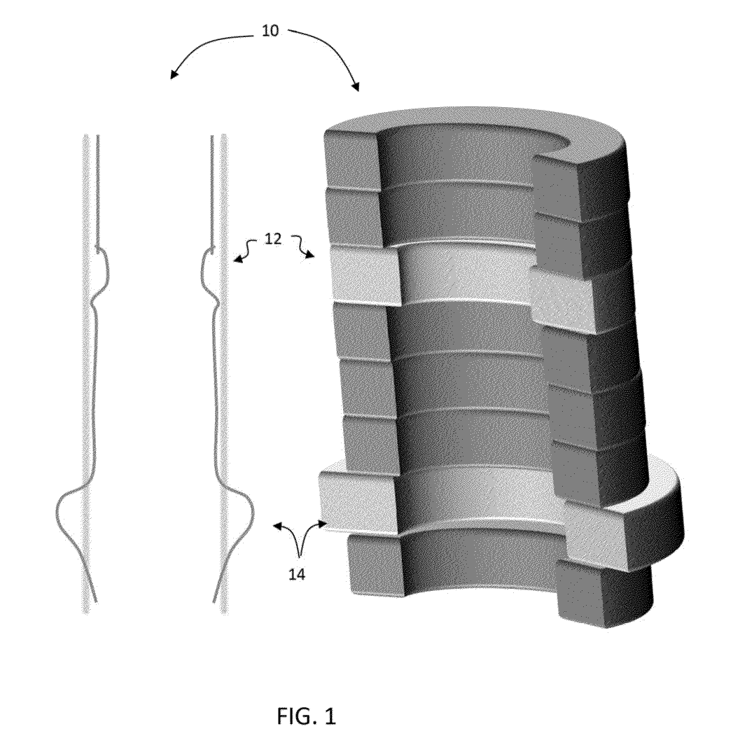

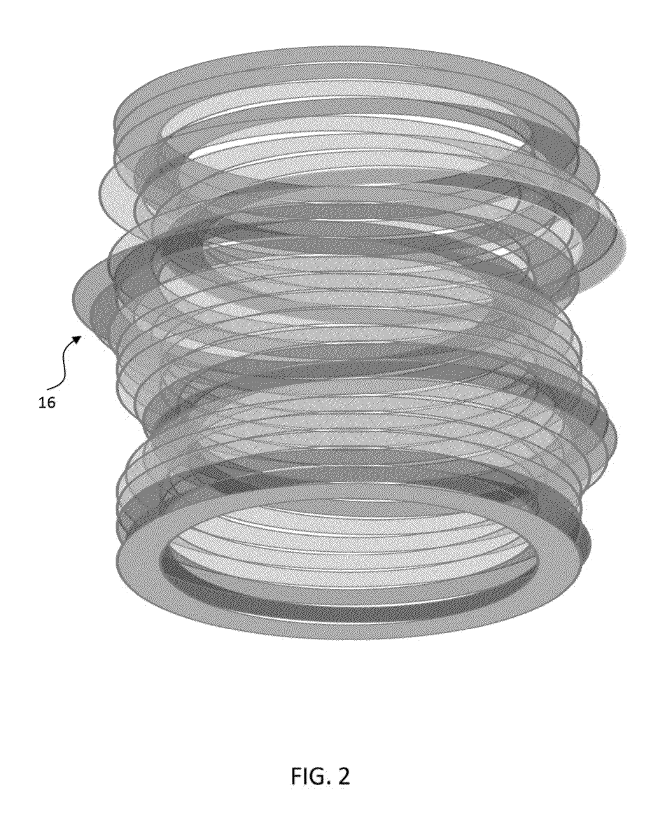

For example, wellbore quality issues may include one or more of a tight connection, excess torque and drag, difficulty in reaching bottom after pulling out of hole, micro doglegs, tortuosity, excess reaming, excess back reaming, high equivalent circulation density, difficulties in reaching the total depth when logging and/or casing the well, loss of circulation, eccentric hole segments, etc. For example, as shown in FIG. 1, a schematic wellbore 10 is illustrated as including a tight hole section 12 as well, as a washout section 14. Further, a schematic of an eccentric hole segment 1 is illustrated in FIG. 2.

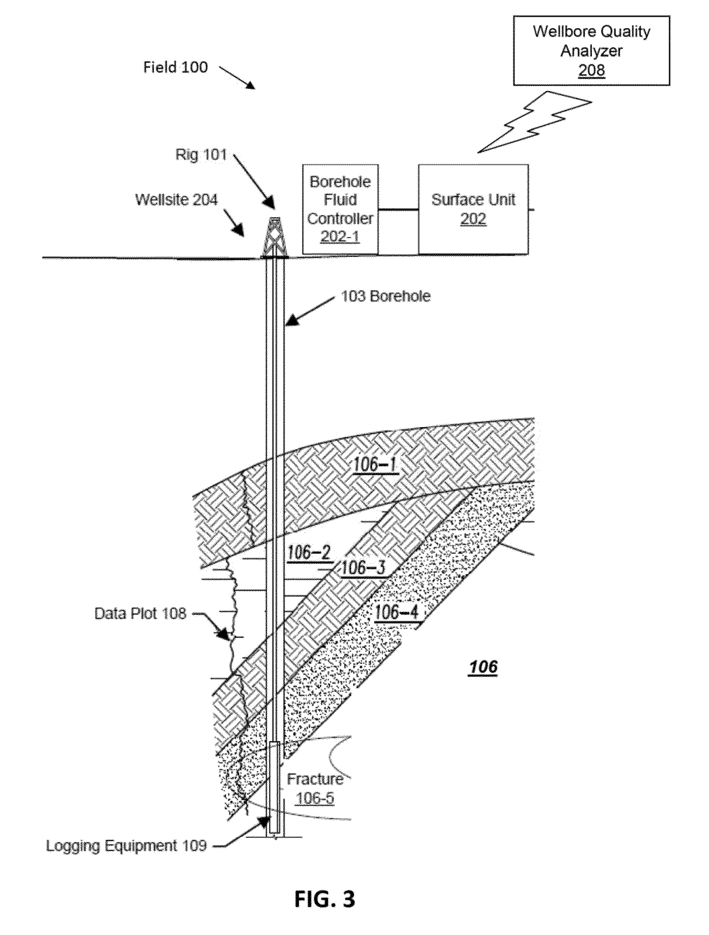

Referring now to FIG. 3, FIG. 3 depicts a schematic view, partially in cross section, of a field 100 in which one or more embodiments of the wellbore quality assessment may be implemented. In one or more embodiments, one or more of the modules and elements shown in FIG. 3 may be omitted, repeated, and/or substituted. Accordingly, embodiments of the logging and analysis disclosed herein should not be considered limited to the specific arrangements of modules shown in FIG. 3.

As shown in FIG. 3, the subterranean formation 106 includes several geological structures. As shown, the formation has a sandstone layer 106-1, a limestone layer 106-2, a shale layer 106-3, a sand layer 106-4, a fracture 106-5, and a reservoir 106-6. Further, the fracture 106-5 may be a natural fracture or a hydraulically induced fracture. In one or more embodiments, various survey tools and/or data acquisition tools are adapted to measure the wellbore and/or the formation and detect the characteristics of the wellbore and/or the geological structures of the formation.

As shown in FIG. 3, the wellsite 204 includes a rig 101, a borehole 103, a borehole fluid controller 202-1, and other wellsite equipment and is configured to perform wellbore operations, such as logging, drilling, fracturing, production, or other applicable operations. Generally, these operations performed at the wellsite 204 are referred to as field operations of the field 100. These field operations are generally performed as directed by the surface unit 202.

In one or more embodiments, the surface unit 202 is operatively coupled to the wellsite 204. In one or more embodiments, surface unit 202 may be located at the wellsite 204 and/or remote locations. The surface unit 202 may be provided with computer facilities for receiving, storing, processing, and/or analyzing data from data acquisition tools (e.g., logging or measurement equipment 109) disposed in the borehole 103, or other part of the field 100. In one or more embodiments, the logging or measurement equipment 109 is installed on a bottom hole assembly (BHA) or a wireline in the borehole 103. The surface unit 202 may also be provided with functionally for actuating mechanisms at the field 100. The surface unit 202 may then send command signals to these actuating mechanisms of the field 100 in response to data received, for example to control and/or optimize various field operations described above.

As noted above, the surface unit 202 is configured to communicate with data acquisition tools (e.g., logging or measuring equipment 109) disposed throughout the field 100 and to receive data therefrom. Surface unit 202 may also receive and/or record data regarding the drilling process, including information about the drilling parameters used in drilling the well. In one or more embodiments, the data received and/or recorded by the surface unit 202 represents characteristics of the subterranean formation 106 and the borehole 103 and may include information related to drilling times, reaming operations, back reaming operations, connections, weight-on-bit, tripping, hole angle, depth, wellbore directional and inclination information, wellbore porosity, saturation, permeability, stress magnitude and orientations, elastic properties, thermal properties, etc. These characteristics of the subterranean formation 106 and the borehole 103 are generally referred to as formation and/or borehole properties that are dependent on the type of rock material in various layers 106-1 through 106-4 of the subterranean formation 106, as well as the type of fluid within the borehole 103 and mechanical structures associated with the borehole 103. In one or more embodiments, the data may be received by the surface unit 202 during a drilling, fracturing, logging, injection, or production operation of the borehole 103. For example, data plot 108 may be a wireline log obtained during a wireline logging operation, logging-while-drilling (LWD) operation, measuring-while-drilling (MWD) operation, or other types of logging operations. Generally, the data plot 108 is a measurement of a formation/borehole property as a function of depth taken by an electrically powered instrument to infer properties and make decisions about drilling and production operations.

In one or more embodiments, the surface unit 202 is communicatively coupled to a wellbore quality index analyzer 208. In one or more embodiments, the data received by the surface unit 202 may be sent to the wellbore quality index analyzer 208 for further analysis. In one or more embodiments, wellbore quality index analyzer 208 estimates the shape and quality of a wellbore (either planned or actual well) using one or more of the sub-indices discussed herein to assess potential risk factors or instances where preventative or remediative measures may be beneficial, for example, using mechanical, chemical, or pressure-based techniques.

Sensors, such as gauges, may be positioned about the well or at the surface to collect data relating to various field operations as described previously Data may be collected by various sensors, for example, during drilling operations. Specifically, drilling tools suspended by a rig may advance into the subterranean formations to form a wellbore (i.e., a borehole). The borehole may have a trajectory in the subterranean formations that is vertical, horizontal, or a combination thereof. Specifically, the trajectory defines the path of the drilling tools in the subterranean formation. A mud pit (not shown) is used to draw drilling mud into the drilling tools via flow line for circulating drilling mud through the drilling tools, up the wellbore and back to the surface. The drilling mud is usually filtered and returned to the mud pit. Occasionally, such mud invades the formation surrounding the borehole resulting in an invasion. Continuing with the discussion of drilling, operations, a circulating system may be used for storing, controlling, or filtering the flowing drilling mud. The drilling tools are advanced into the subterranean formations to reach the reservoir.

The data gathered by the sensors ma be collected by the surface unit 202 and/or other data collection sources for analysis or other processing. The data collected by the sensors may be used alone or in combination with other data. Further, the data outputs from the various sensors positioned about the field may be processed for use. The data may be collected in one or more databases and/or each database or transmitted on or offsite. The entire or select portions of the data may be selectively used for analyzing and/or predicting operations of the current and/or other wellbores. The data may be may be historical data, real time data or combinations thereof. The real time data may be used in real time, or stored for later use. The data may also be combined with historical data or other inputs for further analysis. The data may be stored in separate data repositories, or combined into a single data repository.

Generally, the field operations (e.g., drilling, completions, fracturing, injection, logging, production, or other applicable operations) are performed according to a field operation plan that is established prior to the field operations. The field operation plan generally sets forth equipment, pressures, trajectories and/or other parameters that define the operations performed for the wellsite. The field operation may then be performed according to the field operation plan. However, as information is gathered (for example, including information relating to well quality), the field operation may deviate from the field operation plan. Additionally, as drilling, completions or other operations are performed, the subsurface conditions may change. An earth model may also be adjusted as new information is collected. Such information may include results generated by the wellbore quality index analyzer 208 that is used to identify appropriate changes to the field operation plan to address a new found event. For example, the direction of the well trajectory, wellbore fluids, reaming, hole cleaning/conditioning may be adjusted or executed based on wellbore quality estimated by the wellbore quality index analyzer 208.

As mentioned above, the wellbore quality index may include a plurality of sub-indices or factors, such as a borehole shape index, dogleg severity index, a tortuosity index, and an ovality index. Each will be discussed in turn.

In one or more embodiments, the borehole shape index considers the time spent reaming, back reaming, making connections, time until drilling resumes, and an estimate of whether the amount of weight (or pull) applied reaming and back reaming is significant relative to the weight applied to drilling, each in the context of the amount of time spent drilling. The estimate of whether the amount of weight or pull) applied reaming and back reaming is significant relative to the weight applied to drilling may look at the ratio of:

$$\frac{W O {B}_{ream}}{W O {B}_{drill}} + \frac{{PULL}_{Bream}}{W O {B}_{drill}}$$

If the ratio is greater than a predetermined value, 0.5 for example, this may indicate that a significant amount of reaming and backreaming has occurred, and may result in the addition of a predetermined value (e.g., 1) to the sum of the non-drilling times. This allows for consideration of time spent reaming, back reaming, etc., as well as consideration of how much energy (weight or pull) was put into the reaming and back reaming operations. The total sum may be considered relative to drilling time to result in a percentage of an assessment of the borehole shape (based on time and energy spent reaming and backreaming) as follows:

$$\frac{{t}_{ream} + {t}_{Bream} + {t}_{connection} + {t}_{resume} + {est}_{WOB\_ratio}}{{t}_{drill}}$$

The above ratio may be considered against a predetermined acceptable risk level or may be considered against a predetermined acceptable performance level (where a maximum performance has a value of 1.0 or 100% by considering the value of (1—calculated ratio)). Such results may provide a quantitative indication of relative amount of forces used to drill a specific interval and the forces involved to work out the area to become an open hole.

Further, in one or more embodiments, the well may be a non-vertical well, i.e., having a hole angle, and in such embodiments, the hole angle may result in consideration of the effective applied weight or pull in the direction of the hole. Further, in one or more embodiments, the consideration of the hole angle may depend on whether the amount of pull in backreaming is greater than the acceptable drag for the hole angle.

As mentioned above, another analysis may include a dogleg severity index, in which the trajectory of the wellbore in three-dimensional space changes rapidly. While a dogleg is sometimes created intentionally by directional drillers, dogleg more commonly refers to a section of the hole that changes direction faster than anticipated or desired, generally with harmful side effects. Thus, the dogleg severity indices disclosed herein may be used to provide a quantitative assessment of the severity of the dogleg so that appropriate remediative measures can be taken.

The dogleg severity index may be based on directional and inclination measurements (DLS) obtained from an MWD tool, for example. The DLS measurement may be taken at an incremental depth within the well, such as 100 feet, and may express both the azimuth and inclination of the well. Generally, when a directional well is drilled, there is a planned transition that is considered to be an acceptable transition or acceptable dogleg severity. Thus, conventionally, dogleg severity is measured in 100 foot or 30 meter increments and takes the inclination and azimuth measurements and compares the measured values to the planned dogleg severity. In one or more embodiments, the dogleg severity analysis may evaluate the ratio of the incremental DLS measurement values, i.e., DLSₜ/DLSₜ₋₁, to assess the severity of the well transition from one point to the next.

Further, in one or more embodiments, measurements may be obtained continuously and assessed for presence of microdoglegs. For example, continuous directional and inclination measurements (CDI) may also be obtained from an MWD tool, for example, taken at incremental depths of 10 feet.

Continuous inclination (CI) measurements and continuous directional (CD) measurements may be separately taken and assessed as follows:

$$\frac{{CD}_{t}}{{CD}_{t - 1}} + \frac{{CI}_{t}}{{CI}_{i - 1}}$$

The above ratios may be considered against a predetermined acceptable risk level or may be considered against a predetermined acceptable performance level (where a maximum performance has a value of 1.0 or 100% by considering the value of (1—calculated ratio)). Such results may provide a quantitative indication of severe transitions between two incremental depths.

Ovality may be analyzed by comparing the ratio between two corresponding well diameter measurements taken at substantially the same depth and at substantially perpendicular points. In one or more embodiments, diameter measurements may be taken along an east-west direction and a north-south direction, where the east-west or horizontal direction is considered relative to the vertical or north-south direction. However, one of ordinary skill in the art would appreciate that the reverse may also be considered so long as there is consistency between measurements. The ratio may be considered against a predetermined acceptable risk level or may be considered against a predetermined acceptable performance level (where a maximum performance has a value of 1.0 or 100% by considering the value of (1—calculated ratio)). Such results may provide a quantitative indication of non-cylindrical wells.

Tortuosity considers the shift in or placement of ovality over the continuous length of the well and may be analyzed by multiplying the dogleg severity ratio (or the microdogleg severity ratio) by the ovality ratio in order to assess how the ovality is changed (and the severity of the change) along the length of the well. The ratio may be considered against a predetermined acceptable risk level or may be considered against a predetermined acceptable performance level (where a maximum performance has a value of 1.0 or 100% by considering the value of (1—calculated ratio)). Such results may provide a quantitative indication of non-cylindrical wells.

In one or more embodiments, any of the above sub-indices or wellbore quality factors may be combined together to indicate a total wellbore quality so that appropriate measures can be taken. For example, while each individual sub-index may indicate an acceptable value, when considered in totality by summing the risk (or performance) value, the wellbore may still possess a total risk that is higher than a predetermined acceptable risk level so that remediation is warranted and appropriate measures can be taken before pulling out of the hole. Each wellbore quality factor may have different types or combinations of remedies that may be taken, depending on the circumstances of each well.

In one or more embodiments, any of the above analyses may be performed for an entire well, specific sections of a well, specific stands within a section, within a certain formation type, for a specific bit run, or at a particular depth.

If any of the above analyses result in an unacceptable value (as compared to a predetermined acceptable value), then one or more actions may be taken. In one or more embodiments, the results of the analyses may be visually displayed to a user at the rig site (or a remote location) as a numerical value (e.g., 0.1. 0.5, 5, 10, etc.), a percentage (e.g., 1%, 5%, 90%, etc:), a letter grade (e.g., grade A, grade C, high, low, good, poor, etc.), a color. (e.g., red, yellow, white, etc.), graphically (e.g., as a plot against depth) or any other suitable representation, optionally with identification of the well depth(s) at which potential risks or unacceptable values are located.

In one or more embodiments, such actions may depend, in part, on whether the hole has been drilled to completion (the analysis is being performed in anticipation of subsequent completion operations such as casing the well), is in the progress of being drilled (the analysis is being performed in real-time), or is in the planning stage (in which historical data from offset well(s) is being used). For example, if the analysis is performed during well planning, then the index can be used to modify drilling, parameters (such as WOB, RPM, etc.), drilling practices, or to provide an indication of a need for monitoring of the well during drilling. If the analysis is performed during execution or drilling of a well, then the index can be used to determine whether the drilling plan (and planned remedies) should be continued or modified and to monitor remedies, including a comparison of a theoretical or planned wellbore to the actual wellbore. Further, if the analysis is performed during a post-well review, potential risks for later completion operations can be identified so that completion operations can be modified as needed. In any of such applications, in one or more embodiments, the results of the analyses may be identified in a risk assessment for the next well operator. Some risks factors (and their associated remedies) may be permanently cured by the remedies (reducing the severity of the risk due to reduction in likelihood of occurrence), while other risk factors (such as natural or formation based risks as compared to man-made risks) could re-present themselves despite application of remedies.

Remedies may be classified in mechanical remedies, chemical remedies, and pressure-based remedies. Such remedies may be used to reshape or affect hole shape and quality. For example, mechanical based remedies may include bottom hole assembly selection, hole enlargement by reaming or backreaming (for example to smooth out extreme transitions in a dogleg), wiper trips, conditioning trips, etc. Chemical based remedies may include changing the wellbore fluid chemistry, use of wellbore consolidation or strengthening treatments, etc. Pressure based remedies may include fluid circulation (effecting bottom hole pressure) or changing the fluid density (effecting hydrostatic pressure, for example, to prevent or stop fluid invasion, lost circulation, formation fracture, etc), etc.

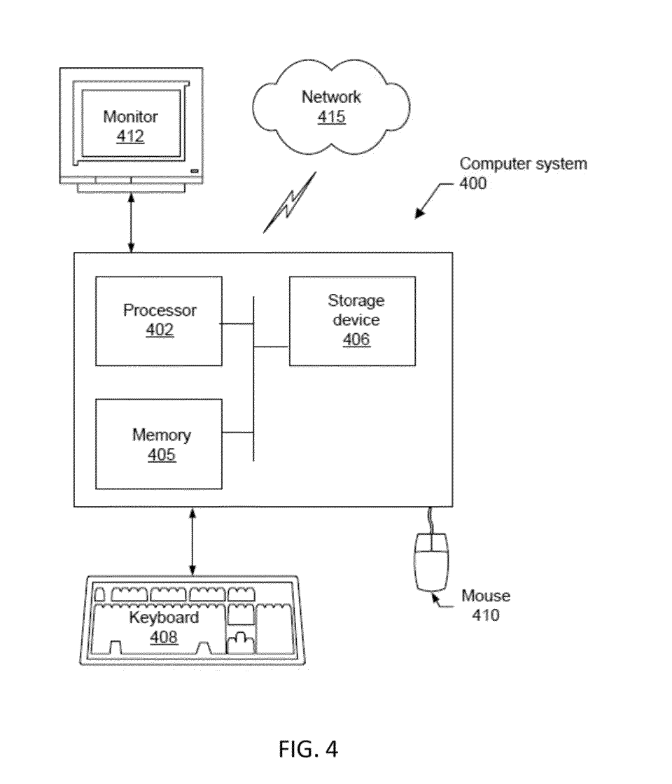

Embodiments may be implemented on virtually any type of computer regardless of the platform being used. For example, as shown in FIG. 4, a computer system 400 includes one or more hardware processor(s) 402, associated memory 405 (e.g., random access memory (RAM), cache memory, flash memory, etc.), a storage device 406 (e.g., a hard disk, an optical drive such as a compact disk drive or digital video disk (DVD) drive, a flash memory stick, etc.), and numerous other elements and functionalities typical of today's computers (not shown). In one or more embodiments, the processor 402 is hardware. For example, the processor may be an integrated circuit. The computer system 400 may also include input means, such as a keyboard 408, a mouse 410, or a microphone (not shown). Further, the computer system 400 may include output means, such as a monitor 412 (e.g., a. liquid crystal display (LCD), a plasma display, or cathode ray tube (CRT) monitor). The computer system 400 may be connected to a network 414 (e.g., a local area network LAN), a wide area network (WAN) such as the Internet, or any other type of network) via a network interface connection (not shown). Many different types of computer systems exist, and the aforementioned input and output means may take other forms. Generally speaking, the computer system 400 includes at least the minimal processing, input, and/or output means to practice embodiments.

Software instructions in the form of computer readable program code to perform embodiments may be stored, in whole or in part, temporarily or permanently, on a computer readable medium such as a compact disc (CD), a diskette, a tape, physical memory, or any other computer readable storage medium. Specifically, the software instructions may correspond to computer readable program code that, when executed by a processor(s), is configured to perform embodiments. In one or more embodiments, the computer readable medium is a non-transitory computer readable medium.

Further, one or more elements of the aforementioned computer system 400 may be located at a remote location and connected to the other elements over a network or transmitted remotely by any available means such as WITSML or any other coding via satellite or landline. Further, embodiments may be implemented on a distributed system having a plurality of nodes, where each portion may be located on a different node within the distributed system. In one or more embodiments, the node corresponds to a computer system. In another embodiment, the node may correspond to a processor with associated physical memory. The node may correspond to a processor or micro-core of a processor with shared memory and/or resources.

Although only a few example embodiments have been described in detail above, those skilled in the art will readily appreciate that many modifications are possible in the example embodiments without materially departing from this invention. Accordingly, all such modifications are intended to be included within the scope of this disclosure. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may he equivalent structures. It is the express intention of the applicant not to invoke 35 U.S.C. § 112, paragraph 6 for any limitations of any of the claims herein, except for those in which the claim expressly uses the words ‘means for’ together with an associated function.

What is claimed:

1. A method of performing wellbore operations, comprising:
calculating, based on measurements obtained by drilling a wellbore, at least one wellbore quality factor of a wellbore quality index;
performing at least one wellbore operation in a wellbore through a subterranean formation, based on the at least one calculated wellbore quality factor.

2. The method of claim 1, wherein the measurements are obtained from an offset well, and the at least one wellbore operation is performed in a neighboring well.

3. The method of claim 1, wherein the measurements are obtained from the same wellbore in which the at least one wellbore operation is performed.

4. The method of claim 1, further comprising:
comparing the calculated wellbore quality factor against a predetermined acceptable wellbore quality factor.

5. The method of claim 1, further comprising:
displaying the results of the comparison.

6. The method of claim 1, wherein the at least one wellbore operation involves a remediative action.

7. The method of claim 6, wherein the remediative action is a mechanical operation.

8. The method of claim 6, wherein the remediative action is a chemical operation.

9. The method of claim 6, wherein the remediative action is a pressure-based operation.

10. The method of claim 1, wherein the at least one wellbore quality factor comprises a borehole shape analysis.

11. The method of claim 1, wherein the at least one wellbore quality factor comprises a dogleg severity analysis.

12. The method of claim 1, wherein the at least one wellbore quality factor comprises an ovality analysis.

13. The method of claim 1, wherein the at least one wellbore quality factor comprises a tortuosity analysis.

14. The method of claim 10, wherein the borehore shape analysis comprises an analysis, relative to an amount of time spent drilling, the time spent reaming, back reaming, making connections, time until drilling resumes, and an estimate of whether the amount of weight applied reaming and pull applied back reaming is significant relative to the weight applied to drilling.

15. The method of claim 11, wherein the dogleg severity analysis analyzes the ratio of a directional and inclination measurement relative to the directional and inclination measurement of a previous increment.

16. The method of claim 15, wherein the incremental directional and inclination measurements are taken substantially continuously.

17. A method of assessing wellbore hole quality, comprising:
calculating, based on measurements obtained by drilling a well, at least one wellbore quality factor of a wellbore quality index;
comparing the calculated wellbore quality factor against a predetermined acceptable wellbore quality factor; and
displaying the results of the comparison.

18. The method of claim 17, wherein the at least one wellbore quality factor comprises at least one of a borehole shape analysis, a dogleg severity analysis, an ovality analysis, or a tortuosity analysis.

19. The method of claim 18, wherein the borehore shape analysis comprises an analysis, relative to an amount of time spent drilling, the time spent reaming, back reaming, making connections, time until drilling resumes, and an estimate of whether the amount of weight applied reaming and pull applied back reaming is significant relative to the weight applied to drilling.

20. The method of claim 18, wherein the dogleg severity analysis analyzes the ratio of a directional and inclination measurement relative to the directional and inclination measurement of a previous increment.
